(19) United States
(12) Patent Application Publication
(10) Pub. No.: US 2024/0070917 A1
(43) Pub. Date: Feb. 29, 2024

(54) METHOD FOR SELF-CALIBRATION OF AT LEAST ONE CAMERA

(71) Applicant: Robert Bosch GmbH, Stuttgart (DE)

(72) Inventors: Annika Hagemann, Hildesheim (DE); Moritz Michael Knorr, Hildesheim (DE)

(21) Appl. No.: 18/352,503

(22) Filed: Jul. 14, 2023

(30) Foreign Application Priority Data
Aug. 24, 2022 (DE) 10 2022 208 757.7

(51) Int. Cl. G06T 7/80

(52) U.S. Cl. CPC G06T 7/80

(57) ABSTRACT

A computer-implemented method for self-calibration of at least one camera. The method comprises: ascertaining at least two corresponding images from a sequence of recorded images, the recorded images resulting from recordings of the camera, the corresponding images having correspondences which are specific to at least one camera parameter, the camera parameter being specific to the geometric imaging behavior of the camera; ascertaining the respective correspondence by an application of an artificial neural network, the application being based on the corresponding images; determining at least the camera parameter based on the ascertained correspondences for the self-calibration of the camera.

### CROSS REFERENCE

The present application claims the benefit under 35 U.S.C. § 119 of German Patent Application No. DE 10 2022 208 757.7 filed on Aug. 24, 2022, which is expressly incorporated herein by reference in its entirety.

### FIELD

The present invention relates to a computer-implemented method for self-calibration of at least one camera. Furthermore, the present invention relates to a method for training a neural network and to an augmentation, a computer program and a device for data processing, in each case for the purpose of self-calibration.

### BACKGROUND INFORMATION

In the related art, a camera or camera systems are used as measuring instruments, for example for automated driving or in robotics. Here, it is often necessary for the geometric imaging behavior to be known precisely. The imaging behavior of cameras is frequently described by a set of parameters, so-called intrinsic camera parameters. The precise determination of these camera parameters can be referred to as camera calibration. Traditionally, this calibration is carried out in a separate procedure before the camera is used. In this case, shots are taken of precisely manufactured calibration bodies, which provide correspondences of 3D points in the real world and 2D points in the image. These correspondences can then be used for estimating the parameters of the imaging function, i.e. the camera parameters. The disadvantage of this classic calibration is the complex procedure which requires equipment and needs to be performed by experts. This is problematic in particular when a regular recalibration is required, such as in the case of safety-critical applications such as automated driving. Here, temperature changes or mechanical influences can affect the camera parameters, which makes regular recalibration necessary.

In contrast to classic calibration, self-calibration is aimed at determining camera parameters during use, doing so on the basis of arbitrary images. The complex calibration procedure is completely bypassed here, and changes in the camera parameters can be detected directly. However, the existing algorithms for self-calibration are often not precise enough, depending on certain requirements being made of the environment, and/or are too computationally intensive.

In the case of self-calibration, it is conventionally possible to distinguish between single-image approaches and video approaches. In addition, a distinction can be made between classic methods and deep learning methods.

In classic single-image approaches, intrinsic camera parameters can be estimated to a certain extent under certain assumptions, such as the assumption of a Manhattan world. In other words, it is assumed that lines in the image must be straight, so that curved lines can be attributed to lens distortion. Furthermore, if several vanishing points are visible in the image, it is possible to estimate the focal length of the camera. However, due to the major assumptions regarding image content, these methods are generally difficult to apply.

Using deep learning, camera parameters can also be predicted on the basis of individual images. In the related art, simple convolutional neural networks have been proposed which receive individual images as input and regress or classify intrinsic camera parameters as output. Extensions of this concept use more elaborate networks, such as transformers, in order to improve precision. However, these methods are strongly dependent on the training data set, and are not sufficiently precise and reliable for safety-critical applications.

Classic structure-from-motion or visual SLAM use image sequences in which the camera has been moved in order to estimate the three-dimensional structure of the imaged scene and the camera movement. Classically, these approaches are based on the detection of distinctive points (keypoints) in the image, and on finding keypoints that correspond across images. The camera movement and three-dimensional structure can then be estimated by using the geometric relationship between corresponding image points pᵢ and pⱼ in two images i,j:

pⱼ=π(Gᵢⱼ·π⁻¹(pᵢ,z_{i,p},θ)) (1)

Here, G_{i,j} ∈ SE(3) describes the relative camera pose, z_{i,p} the depth, and θ the intrinsic camera parameters, also referred to as intrinsics. The function π describes the camera projection of 3D into the image, and π⁻¹ the inverse projection. Although the intrinsic camera parameters are usually assumed to be known, they can also be optimized, as is possible, for example, in COLMAP.

Deep learning approaches for video-based self-calibration have so far been limited to learning camera parameters of a special camera. This means that a network must be trained on the basis of many images from the same camera, whereby intrinsic camera parameters such as weights are optimized. This requires many training images and a computing time of over 12 hours for self-calibrating a camera (see [1]). An explicit prediction of varying intrinsic parameters during the use of the camera is therefore not practicable.

Regardless of a camera calibration, in recent years the first methods have been developed that combine deep learning with classic geometric optimization (see [2]). In this case, first a classic convolutional network is used for feature extraction, and a further network for searching for correspondences across images. Finally, these correspondences are used in a classic optimization for estimating camera poses and depths. The classic optimization is formulated here in such a way that backpropagation can take place through the optimization steps. For depth estimation and motion estimation, this type of approach has already been developed, and it has been demonstrated that the systems generalize well with new data. Camera calibration has not been made possible as a result.

The present invention provides a computer-implemented method, a training method, an augmentation method, a computer program, and a device. Features and details of the present invention are disclosed herein. Here, features and details which are described in connection with the computer-implemented method according to the present invention also apply, of course, in connection with the training method and augmentation method according to the present invention, the computer program product according to the present invention as well as the device according to the present invention, and vice versa in each case, so that with regard to the disclosure of individual aspects of the present invention, reference to the individual aspects of the present invention is always made reciprocally or can be so made.

Below, parameters which characterize the geometric imaging behavior and/or the position and/or orientation of the camera are referred to as camera parameters. Parameters which characterize the geometric imaging behavior of the camera are here preferably referred to as intrinsic camera parameters, or intrinsics. They can contain the focal length, the principal point, and/or distortion parameters, as well as any parameters describing how a 3D point is mapped onto the image. Parameters which characterize the position and/or orientation of the camera relative to another camera or to another reference object statically connected to the camera can be referred to as extrinsic parameters or extrinsics.

In particular, the position and/or orientation of the camera relative to a reference coordinate system and/or to an object is referred to as the relative camera pose. This can change with the movement of the camera or with the movement of the reference coordinate system or of the object. The object can be an object in the surroundings of the camera, which is imaged in the images according to the geometric imaging behavior. In particular, the z-component of the 3D coordinates of points in the 3D world, measured in relation to the coordinate system of the camera, is referred to as depth. In this case, the z-axis points in particular in the direction of the optical axis of the camera. A pixelwise depth assigns to each pixel in the image the depth of the 3D point imaged there.

Below, images with an at least partially overlapping field of view are preferably referred to as corresponding images.

Accordingly, the corresponding images can comprise such images which together form an image of an object.

Below, correspondence preferably refers to the presence of a common image in the sense that a pair of image points which image the same 3D point or the same object occur in two different images, i.e., in the corresponding images. The correspondence can preferably be found in the feature space, in which case the correspondence specifically denotes a pair of points in the feature maps of two different (corresponding) images, wherein the points characterize the same 3D point. A correspondence may be uniquely defined by the camera's intrinsics, the relative pose from which the corresponding images were recorded, and the 3D structure of the imaged scene. The totality of all three items of information can uniquely define the correspondence. Conversely, a set of measured correspondences may provide information about the camera's intrinsics, the relative pose, and the 3D structure of the imaged scene. Correspondences can thus be ascertained or measured by means of color information in the image and used to estimate the above-mentioned three variables.

Estimation or determination of at least one camera parameter can be referred to as self-calibration. The camera parameter can then be used to correct the images recorded by the camera.

The present invention includes a computer-implemented method for self-calibration of at least one camera. According to an example embodiment of the present invention, the method includes the following steps, wherein the steps are preferably carried out automatically and/or sequentially:
ascertaining at least two corresponding images from a sequence of recorded images, wherein preferably the recorded images result from recordings of the camera, wherein preferably the corresponding images have correspondences, in particular between different image points of the images, which are specific to at least one camera parameter and preferably to a relative camera pose and/or depth, wherein preferably the camera parameter is specific to the geometric imaging behavior of the camera, and wherein advantageously the relative camera pose is specific to a relative movement of the camera (and in particular an environment of the camera, i.e., for example, objects in the environment relative to the camera) between the recordings, wherein the relative movement can preferably comprise a movement of the camera itself and/or of 3D points and/or objects in the environment relative to the camera,
ascertaining, preferably predicting, i.e. in particular estimating, the respective correspondence by an application of an artificial neural network, wherein the application is carried out on the basis of the corresponding images and preferably on the basis of an initial estimation of the correspondence, and wherein the initially estimated correspondence is determined by an initial estimation of the relative camera pose and/or of the camera parameter and/or of the depth, wherein the application of the network is preferably carried out as a correspondence search,
determining, i.e. in particular estimating, at least the camera parameter on the basis of the ascertained correspondences for the self-calibration of the camera, preferably by an optimization on the basis of the ascertained correspondence.

The present invention may have an advantage that a determination of the at least one camera parameter, in particular intrinsic camera parameter, is possible on the basis of any image sequences in which the camera has been moved. The method can thus be used to calibrate cameras on-line, and to detect incorrect calibrations or drifts in camera parameters during the use of the camera. The method combines in particular the good performance capability of deep learning for feature extraction and correspondence searching and the accuracy and generalizability of classic geometric optimization. Through this hybrid approach, a high accuracy and an acceptable computing time can be achieved.

The sequence can be a sequence of images, for example in the form of a video in which the camera has been moved. The relative camera pose (referred to as pose for short) can be dependent on the camera movement. The geometric relationship can be given by the 3D scene, in particular by a depth, the camera pose and the camera parameters, preferably according to Eq. 1.

Furthermore, according to an example embodiment of the present invention, it can be provided that the determination of at least the camera parameter comprises an execution of an optimization method in which the camera parameter is estimated from the ascertained correspondences, wherein the correspondences are preferably ascertained image-point-wise, in particular pixelwise, and the optimization method is carried out on the basis of the correspondences for several image points or pixels of the corresponding and/or of further corresponding images in the sequence. The method according to the present invention thus combines in particular the advantages of deep learning with classic geometric optimization. Furthermore, it is possible that the optimization method is performed iteratively, wherein after a defined number of iterations the step of ascertaining the respective correspondence is repeated, wherein preferably an initial estimation of the correspondence in each iteration corresponds to the result of the preceding iteration.

Furthermore, according to an example embodiment of the present invention, it can be provided that the following step is provided before the ascertainment:
performing an extraction of features of the corresponding images, preferably by a further neural network.

Furthermore, according to an example embodiment of the present invention, the ascertainment of the respective correspondence can comprise the following steps, wherein the respective correspondence is preferably ascertained as a correspondence between an image point, in particular pixels, of a first image of the corresponding images and an image point or pixels of a second image of the corresponding images, wherein the ascertainment is preferably carried out as a prediction of the respective correspondence:
ascertaining a correlation on the basis of the extracted features for the initially estimated correspondence, wherein the correlation is preferably ascertained for this purpose as a correlation between the extracted features in the environments of the image points or pixels,
using the ascertained correlation and the initially estimated correspondence as an input for the neural network in order to use an output of the neural network as a correspondence that has been improved compared to the initial estimation.

The correlation can be ascertained, for example, on the basis of the “feature maps” obtained from a feature extraction, wherein the scalar product of the “feature vectors” is preferably calculated, and is preferably specific to a match and/or similarity of the different images in the environments of the initial correspondence.

In addition, it is advantageous if the ascertainment of the respective correspondence comprises the following steps:
initial ascertainment of a geometric relationship between the corresponding images on the basis of the initial estimation of the relative camera pose and the camera parameter,
determining an input of the neural network on the basis of the ascertained geometric relationship, wherein an output of the neural network is used as the ascertained, in particular predicted, correspondence.

In this case, in the step of determining at least the camera parameter, the relative camera pose and/or a depth of the geometric relationship can preferably be determined by further processing of the ascertained correspondences. Furthermore, this determination can optionally be carried out by optimizing the camera parameters.

It is also advantageous if, within the scope of an example embodiment of the present invention, the ascertainment of the respective correspondence comprises a transformation based on a first image of the corresponding images, wherein the transformation is performed on the basis of an initial estimation of a relative camera pose and/or a depth and/or the camera parameter, wherein the result of the transformation is compared on the basis of a second image of the corresponding images in order to evaluate the estimation. The ascertainment of the correspondences can also be referred to as correspondence searching. Here the correspondence search can take place image point by image point in the image area of the images, but preferably on the basis of feature maps. The feature maps can have a fraction of the resolution of the original images. Instead of the color channels, a different number of channels for the extracted features can even be provided in the feature maps.

According to an example embodiment of the present invention, the ascertainment of the respective correspondence is carried out image-point-wise, in particular pixelwise, for the corresponding images, wherein a first image of the corresponding images is transformed image-point-wise, in particular pixelwise, by means of an initial estimation of the relative camera pose and of the camera parameter, and the result of the transformation is compared, preferably image-point-wise, with a second image of the corresponding images in order to evaluate the estimation. The transformation can also be referred to as “warping”, and uses the camera pose as a combination of position and orientation and/or depth and/or intrinsics. The camera pose can here be described as an element of the “special Euclidean group” SE(3). Furthermore, the transformation can comprise a camera projection. The transformation takes place, for example, due to the geometric relationship according to Eq. 1. For example, each image point or each pixel in the first image i is transformed according to the second image j, i.e. \hat{p}ⱼ=π(Gᵢⱼ·π⁻¹(pᵢ,z_{i,p}θ)).

According to an example embodiment of the present invention, it can also be possible for the ascertainment of the respective correspondence to be carried out image-point-wise, in particular pixelwise, for the corresponding images, wherein in each case an optimization weight is ascertained and assigned to the ascertained correspondence. As a result, the predicted correspondences can be taken into account differently in the optimization. The optimization weight specifies, for example, a probability for the correctness of the ascertained correspondence.

Furthermore, it is possible that the ascertained correspondences are in each case output by a residual and an assigned optimization weight is output by the neural network, wherein the determination of at least the camera parameter for the self-calibration can comprise the following steps:
performing an optimization by weighting the residuals on the basis of the optimization weights,
performing the self-calibration on the basis of a result of the optimization.

Here the self-calibration can be carried out for one or more cameras, wherein the at least one camera is, for example, a camera of a vehicle or robot. The result of the optimization can include the camera parameter which can be used for self-calibration.

In addition, it can be advantageous within the scope of an example embodiment of the present invention that the optimization comprises an iterative implementation of Gauss-Newton steps, wherein after each iteration and/or after a defined number of iterations, the step of ascertaining the respective correspondence is repeated in order to ascertain the residual and the assigned optimization weight again in each case.

Furthermore, it is optionally possible within the scope of an example embodiment of the present invention for the neural network to be designed as a deep neural network and/or as a convolutional neural network and/or as a recurrent neural network.

According to an example embodiment of the present invention, it can preferably be provided that the self-calibration comprises a determination of a current intrinsic camera parameter of the camera during ongoing operation of the camera, wherein the neural network has been trained for ascertaining the respective correspondence before the self-calibration.

The present invention also provides a method for training an artificial neural network for ascertaining correspondences. According to an example embodiment of the present invention, the method form training includes the following steps:
providing training data which are specific to images recorded by at least one camera, wherein the images contain corresponding images, and in which the correspondences between the images and/or the relative camera poses and/or the camera parameters are preferably predefined as ground truth, wherein the correspondences are specific to varying camera parameters and preferably to a relative camera pose, wherein preferably the camera parameters are specific to the geometric imaging behavior of the camera, and/or wherein the relative camera pose is specific to a movement of the camera between the recordings,
performing training on the basis of the training data.

Furthermore, it is possible that, after performing the training, a method according to the present invention is carried out in which the trained network is used as the artificial neural network for ascertaining the respective correspondence.

Furthermore, it is possible for the training data to be specific to varying camera parameters by the training data being based on images of different camera lenses, in particular of different focal length, and/or different lens distortions, in particular by use of fisheye lenses.

It is also possible that at least one of the following cost functions is provided during the training:
a cost function which is specific to a deviation of the camera parameter estimated in an optimization method from a camera parameter specified by the ground truth,
a cost function which is specific to a deviation of a predicted correspondence from the correspondence specified by the ground truth,
a cost function which is specific to a deviation of camera poses estimated in an optimization method from camera poses specified by the ground truth,
a cost function quantifying a photometric error.

Furthermore, it can be provided within the scope of the present invention that the training data are produced synthetically.

According to an example embodiment of the present invention, the at least one camera can be used as a measuring instrument. The at least one camera can thus comprise, for example, a camera of a vehicle which is used for capturing an environment of the vehicle. This recording is used for example for an (at least partially) autonomous driving function of the vehicle. For this purpose, the at least one camera can be in data connection with a control unit of the vehicle. Furthermore, it is possible that the at least one camera comprises a camera of a robot in order to be used for robot control.

Furthermore, the method according to the present invention can optionally also be applied to a multi-camera system, so that the at least one camera comprises a plurality of cameras, wherein not only the intrinsic, but also the extrinsic camera parameters are estimated.

Furthermore, according to an example embodiment of the present invention, it can be provided that, in order to increase an efficiency of the method, at least one of the following steps is performed:
analytical calculation of the Jacobi matrices used in the optimization via application of the multidimensional chain rule,
utilizing the block structure of the Hessian matrix of the optimization, and determining the optimization step via the Schur complement, wherein in particular a block corresponds to the intrinsic parameters combined with the pose parameters (i.e. the relative camera pose), a further block corresponding to the depth parameters, and the other remaining two blocks corresponding to the mixing terms,
parallelized implementation of the matrix operations in the optimization step in a GPU (graphics processing unit).

It is also possible that a result of the determination of at least the camera parameter is used to check the reliability of the poses and/or depth estimates. Furthermore, it is possible for the method to be carried out for a multi-camera calibration and estimation of the extrinsics.

The present invention also provides an augmentation method for generating training data for a training method according to the present invention, wherein the following steps are carried out:
transforming recorded and/or synthetic images which are specific to images recorded by at least one camera, wherein a camera parameter of the images is varied by the transformation,
generating the training data from the transformed images.

The present invention also relates to a computer program, in particular a computer program product, comprising instructions which, when the computer program is executed by a computer, cause the computer to carry out the method(s) according to the present invention. The computer program according to the present invention thus brings with it the same advantages as have been described in detail with reference to the method(s) according to the present invention.

For example, a data processing device which executes the computer program can be provided as the computer. The computer can have at least one processor for executing the computer program. A non-volatile data memory can also be provided, in which the computer program is stored and from which the computer program can be read by the processor for execution.

The present invention also relates to a computer-readable storage medium which comprises the computer program according to the present invention. The storage medium is designed, for example, as a data store such as a hard drive and/or a non-volatile memory and/or a memory card. The storage medium can be integrated into the computer, for example.

The present invention also relates to a device for data processing which is designed to carry out a method according to the present invention. The device according to the present invention thus brings with it the same advantages as have been described in detail with reference to a method according to the present invention.

Further advantages, features and details of the present invention will become apparent from the following description, in which exemplary embodiments of the present invention are described in detail with reference to the figures. The features disclosed herein can be essential to the present invention in each case individually or in any combination.

### BRIEF DESCRIPTION OF THE DRAWINGS

FIG. 1 shows a schematic representation of a method according to an example embodiment of the present invention.

FIG. 2 shows a schematic representation of a block structure of a Hessian matrix which can be used in the proposed optimization, according to an example embodiment of the present invention.

FIG. 3 shows a schematic representation of a method according to an example embodiment of the present invention with further details.

FIG. 4 shows examples of trajectories estimated by the method according to an example embodiment of the present invention.

FIG. 5 shows schematic method steps of a method according to an example embodiment of the present invention.

### DETAILED DESCRIPTION OF EXAMPLE EMBODIMENTS

The details of the present invention discussed below are based in part on conventional methods, e.g., for predicting optimization residuals and weights by means of deep learning. For further details, reference is therefore made to publications [1] and [2], whose content is incorporated in the disclosure herein of the present invention.

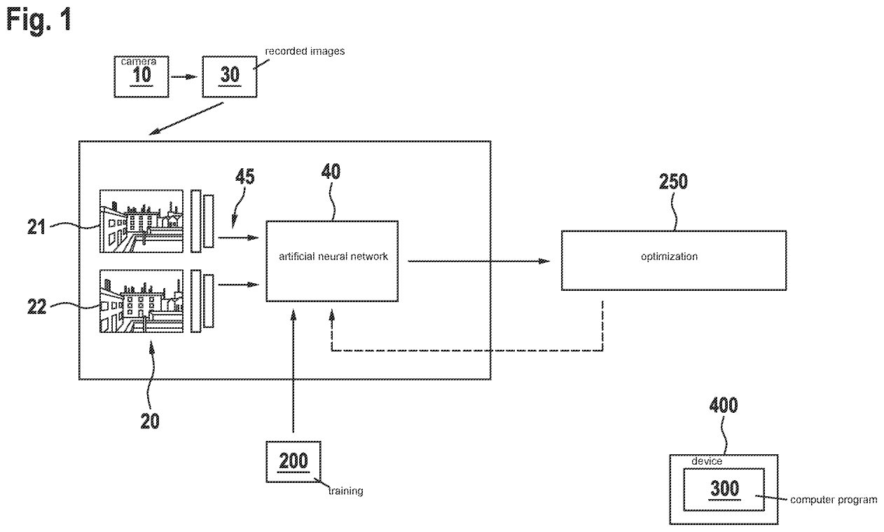

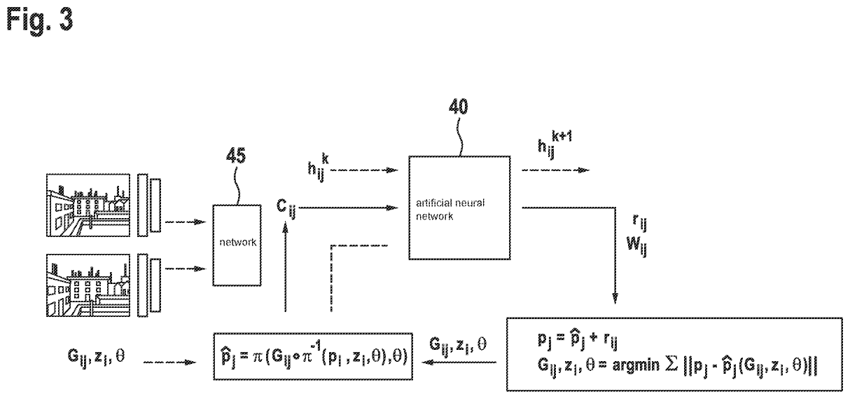

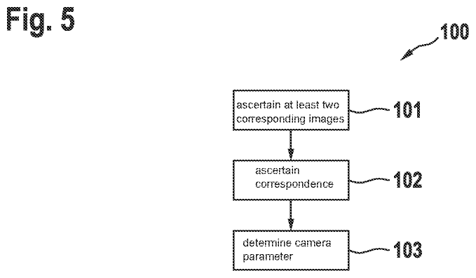

As shown in FIG. 1 and with further details in FIG. 3 and FIG. 5, the method 100 according to the present invention first involves ascertaining 101 at least two corresponding images 20 from a sequence of recorded images 30. The recorded images 30 can result from recordings of the camera 30. The recording may have been carried out beforehand in such a way that a movement such as a rotational movement of the camera 30 was made between the recordings. The corresponding images 20 can have correspondences, for example pixelwise correspondences, which are specific to at least one camera parameter and to a relative camera pose. The correspondences can thus relate to objects which are imaged together by the corresponding images 20 (i.e. an overlap). However, the images of the objects differ due to the movement of the camera 10 and due to the geometric imaging behavior of the camera 10. The at least one camera parameter is specific to the geometric imaging behavior of the camera 10. The relative camera pose is specific to the movement of the camera 10 between the recordings.

Next, the respective correspondence can be ascertained 102 by an application of an artificial neural network 40, wherein the application can be carried out on the basis of the corresponding images and preferably on the basis of an initial estimation of the correspondence, and wherein the initially estimated correspondence can be determined by an initial estimation of the relative camera pose and of the camera parameter.

In a further step of the method 100 according to the present invention, a determination 103, preferably a prediction, of at least the camera parameter can be carried out on the basis of the ascertained correspondences for the self-calibration of the camera 10.

It is also possible that the ascertainment 102 of the respective correspondence comprises a transformation based on a first image 21 of the corresponding images 20, which is carried out on the basis of an initial estimation of a relative camera pose and/or of a depth and/or of the camera parameter, wherein the result of the transformation is compared on the basis of a second image 22 of the corresponding images 20 in order to evaluate the estimation. Furthermore, it can be provided that the determination 103 of at least the camera parameter comprises an execution of an optimization method 250 in which the camera parameter is estimated from the ascertained correspondences, wherein the correspondences are preferably ascertained pixelwise and the optimization method 250 is carried out on the basis of the correspondences for several pixels of the corresponding and/or further corresponding images 20 in the sequence.

FIG. 1 also schematically visualizes a training method 200 according to the present invention and a computer program 300 according to the present invention and a device 400 according to the present invention.

Further exemplary embodiments of the present invention are discussed below, in which the method steps are described on the basis of an image pair as the at least two corresponding images 20. Of course, the present invention and the exemplary embodiments are not limited to image pairs.

For self-calibration, a feature extraction of the sequence of images 30 can be carried out first. The feature extraction can be carried out, for example, by using a further network 45, as shown in FIGS. 1 and 3, such as a convolutional neural network (CNN for short, also referred to as a convolution network). This network 45 can be designed such that the resolution of the image is reduced, but does not become excessively low (e.g. by a reduction to ⅛ of the original resolution). The feature maps generated in the CNN are used in the following to find close correspondences between image pairs. For each image pair (i,j) an initial estimation of the relative pose Gᵢⱼ ∈ SE(3), of the pixelwise depths z_{i,p}, where p denotes the respective pixel, and of the intrinsic camera parameters θ can be present here. If there is no information about the camera and scene, agnostic initial values can optionally be set. The initial parameters are thus given. It is now possible to transform each pixel in imagei into image j, in other words \hat{p}ⱼ=π(Gᵢⱼ·π⁻¹ (pᵢ,z_{i, p},θ)) is determined. Since the initial parameters are not usually correct, \hat{p}ⱼ≠pⱼ, in other words the transformed pixel, is not equal to the pixel of the actual correspondence. In order to find the actual correspondence, a correlation is now determined between the feature maps in an environment of pᵢ and the feature maps in an environment of \hat{p}ⱼ. This is based on the expectation that the actual correspondence pⱼ has particularly high similarity to pᵢ. In principle, it can now be ascertained directly for which p′ⱼ the correlation between feature maps is particularly high and this p′ⱼ can be passed on as a correspondence. However, it is advantageous if this correspondence search is also carried out on the basis of learned parameters. That is to say, the ascertained correlations are passed on to a neural network, for example a convolutional gated recurrent unit (GRU). In this case, the neuronal network not only predicts the correspondence for each pixel, but also additionally predicts optimization weights which quantify how high the uncertainty of a correspondence is, and to what extent it is to be taken into account in the following optimization. In particular, the prediction of correspondences and weights can be made via a correlation volume and a gated recurrent unit (GRU), as in [2]. By using a recurrent network, such as a GRU, the correspondence search and the subsequent classic optimization (see next paragraph) can be carried out iteratively, wherein in each iteration the “hidden state” is updated. The predicted correspondence thus iteratively approaches the true correspondence.

For the intrinsic camera calibration, the predicted correspondences and weights can be used for the optimization of the intrinsic camera parameters. The intrinsic camera parameters can be optimized simultaneously with the depths and the relative camera poses. The residuals can here be weighted according to the predicted weights, wherein classic Gauss-Newton steps can be carried out:

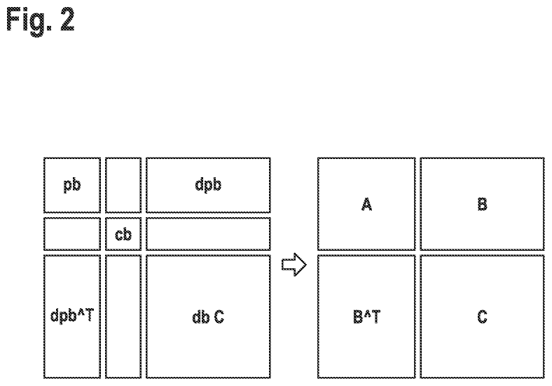

J^{T}JΔξ=J^{T}r (2)

where Δξ=(ΔG,Δθ,Δz)^{T} describes the parameter update of relative camera poses (poses for short), intrinsics and depths, r the residuals, and J the Jacobi matrix of the optimization. The product H=J^{T}J designates the Hessian matrix of the optimization. In this case, in particular, the block structure of the Hessian matrix shown schematically in FIG. 2 is utilized, which makes a solution possible by means of a Schur complement. The block structure can be utilized by combining pose parameters and intrinsic camera parameters: Δξ_{G,θ}=(ΔG,Δθ)^{T} and J^{Tr}=(\tilde{r}_{G,θ},\tilde{r}_{z})^{T}. The Gauss-Newton step can then be described as

$$[ \begin{matrix}A & B \\ {B}^{T} & C\end{matrix} ] [ \begin{matrix}{Δξ}_{G , θ} \\ Δ z\end{matrix} ] = [ \begin{matrix}{\tilde{r}}_{G , θ} \\ {\tilde{r}}_{z}\end{matrix} ] \qquad ( 3 )$$

and the solution is given by the Schur complement by

Δξ_{G,θ}=[A−BC⁻¹B^{T}]⁻¹(\tilde{r}_{Gθ}−BC⁻¹\tilde{r}_{z}, (4)

Δz=C⁻¹(\tilde{r}_{z}−B^{T}Δξ_{G,θ}). (5)

After each Gauss-Newton step, the correspondences and optimization weights can be ascertained again. The total number of Gauss-Newton steps can be selected as a compromise between computing time and accuracy.

FIG. 2 schematically shows a block structure of the Hessian matrix. Here, pb denotes a “pose block”, dpb a “depth-pose block”, cb a “calib block” and db a “depth block”.

Since both training and inference involve a multiple calculation of the Jacobi matrix J, the derivatives contained therein can be derived analytically and implemented accordingly. For a pinhole model, this can be done as follows:

Through improvement of the computation times for the training, the Jacobi matrices of the optimization residuals can be derived analytically for all parameters. The derivation of the calibration Jacobi matrices is indicated below by way of example for a pinhole model. However, the method according to the present invention is not limited to the pinhole model but can be applied for any camera model. The optimization residuals are given by

rᵢⱼ=pⱼ−π(Gᵢⱼ·π⁻¹(pᵢ,z_{i,p},θ) (6)

where pᵢ and pⱼ are the measured corresponding points in image or image J. Gᵢⱼε(3) denotes the relative camera pose, z_{i,p} denotes the depth, and θ=(fₓ,f_{y},cₓ,c_{y}) are the intrinsic camera parameters of the pinhole model. The function n describes the projection of 3D onto the image, and π⁻¹ the inverse projection. For a pinhole model, they are given by

$$π ( x , θ ) = [ \begin{matrix}{f}_{x} \frac{x}{z} + {c}_{x} \\ {f}_{y} \frac{y}{z} + {c}_{y}\end{matrix} ] and \qquad ( 7 )$$

$${π}^{- 1} ( p , θ , z ) = [ \begin{matrix}\begin{matrix}\begin{matrix}\frac{{p}_{x} - {c}_{x}}{{f}_{x}} \\ \frac{{p}_{y} - {c}_{y}}{{f}_{y}}\end{matrix} \\ 1\end{matrix} \\ z\end{matrix} ]$$

The Jacobi matrix can be calculated using the chain rule:

$$\frac{d {r}_{i j}}{d θ} = - \frac{d}{d θ} π ( {G}_{i j} ∘ {π}^{- 1} ( {p}_{i} , {z}_{i} , θ ) ) \qquad ( 8 )$$

$$Here g ( θ ) = {G}_{i j} ∘ {π}^{- 1} ( {p}_{i} , {z}_{i , p} , θ ) , so that$$

$$\frac{d {r}_{i j}}{d θ} = - \frac{d}{d θ} π ( g ( θ ) , θ ) \qquad ( 9 )$$

$$= - \frac{d π ( g ( θ ) , θ ) d g ( θ )}{d g ( θ ) d θ} - \frac{d π ( g ( θ ) , θ )}{d θ} \frac{d θ}{d θ} \qquad ( 10 )$$

$$= - \frac{d π ( {x}_{j} , θ )}{d {x}_{j}} \frac{d {x}_{j}}{d {x}_{i}} \frac{d {π}^{- 1} ( {p}_{i} , {z}_{i} , θ )}{d θ} - \frac{d π ( g ( θ ) , θ )}{d θ} \frac{d θ}{d θ} \qquad ( 11 )$$

wherein in the last step xᵢ=π⁻¹(pᵢzᵢ, θ) and xⱼ=(R|t)ᵢⱼ xᵢ have been partially replaced for better readability. The various components in (11) can be found on the basis of the projection function. To be more precise:

$$\frac{d π ( {x}_{j} , θ )}{d {x}_{j}} = [ \begin{matrix}\frac{{f}_{z}}{{z}_{j}} + {c}_{x} & 0 & - {f}_{x} \frac{{x}_{j}}{{z}_{j}^{2}} & 0 \\ 0 & \frac{{f}_{y}}{{z}_{j}} & - {f}_{y} \frac{{y}_{j}}{{z}_{j}^{2}} & 0\end{matrix} ] \qquad ( 12 )$$

$$\frac{d {x}_{j}}{d {x}_{i}} = {( R \vert t )}_{ij} \qquad ( 13 )$$

$$\frac{d {π}^{- 1} ( {p}_{i} , {z}_{i} , θ )}{d θ} = [ \begin{matrix}- \frac{{p}_{x} - {c}_{x}}{{f}_{x}^{2}} + {c}_{x} & 0 & - \frac{1}{{f}_{x}} & 0 \\ 0 & - \frac{{p}_{y} - {c}_{y}}{{f}_{y}^{2}} & 0 & - \frac{1}{{f}_{y}} \\ 0 & 0 & 0 & 0 \\ 0 & 0 & 0 & 0\end{matrix} ] \qquad ( 14 )$$

$$\frac{d π ( g ( θ ) , θ )}{d θ} = [ \begin{matrix}\frac{{x}_{j}}{{z}_{j}} & 0 & 1 & 0 \\ 0 & \frac{{y}_{j}}{{z}_{j}} & 0 & 1\end{matrix} ] \qquad ( 15 )$$

$$\frac{d θ}{d θ} = I \qquad ( 16 )$$

These matrices can be used in equation (11) to obtain the total Jacobi matrix of the residuals with respect to the pinhole intrinsics. The Jacobi matrices for other camera models, such as the Mei model, can be derived analogously, but the individual derivations are more complicated due to the additional parameter.

The method can be implemented as a SLAM system which consists of a front end and a back end, and in which images are successively added.

In order to achieve faster computing time, the Gauss-Newton optimization for the inference can be implemented in a CUDA kernel. In this case, the calculations of Jacobi matrices, as well as of their matrix products, required in the Gauss-Newton step are parallelized.

The system can also be trained end-to-end. For this purpose, a training data set is provided which contains image sequences, optionally with known intrinsics, pose, and depth. In the training, the method (including feature extraction, correspondence prediction, and optimization method) is applied to sets of at least two corresponding images from the training data set. At least one of the following cost functions is then calculated:
A cost function that is specific to the deviation of the intrinsics estimated in the optimization procedure from the known ground-truth intrinsics. In particular, a weighted sum can be used here via the quadratic deviations of the individual estimated intrinsic parameters from the associated ground-truth intrinsic parameters. Alternatively, the deviation in the image space can be ascertained by projecting into the image a set of 3D points with both intrinsics, and quantifying a mean distance between the image points.
A cost function that is specific to the deviation of the predicted correspondence from the known ground-truth correspondence, in particular the deviation of the predicted corresponding image points from a ground-truth optical flow. This function can be defined as a mean square deviation of the flow vectors, as defined in publication [1].
A cost function that is specific to the deviation of the poses estimated in the optimization procedure from the known ground-truth poses. Here too, as in publication [1], a sum over the quadratic pose deviations is used.
A cost function quantifying a photometric error. Here, an image i is “warped” or transformed to form an adjacent image j by means of the geometric relationship (1) on the basis of the current estimation of pose, intrinsics and depth. The cost function now quantifies a difference in the color values of image j and the warped image i, which is known as photometric loss. This cost function can be used, in particular, if there is no ground-truth depth, pose and/or intrinsics available for the training data.

By applying backpropagation, the weights in the neural network, which, for example, contains a CNN for feature extraction and a GRU for correspondence searching, can be updated, whereby the cost function is minimized.

The system can also be trained specifically for self-calibration by setting the initial values of the intrinsic camera parameters in the training to differ from the ground truth. Furthermore, an augmentation method can be performed on the basis of a training data set. Here the original training data set contains image sequences that are specific to images recorded by at least one camera, wherein the associated intrinsic parameters of the camera(s) are assumed to be known.

In the augmentation method, images with other intrinsic parameters and/or other camera models can now be artificially generated. This can be achieved by performing a transformation such as a warping. Here new images are generated, whereby color values of the pixels of a new image are ascertained via the color values of the original image as follows: given a pixel in the new image with coordinates (u′,v′), a new camera model π′ and new intrinsic parameters θ′, the image point (u′,v′), is now projected out of the image using the inverse new camera model, which provides the associated visual ray. Any point on this visual ray will now be projected into the original image using the original camera model π and the original intrinsic parameters θ, which supplies an associated original image point (u,v). The color value of the original image at the location (u,v) is now used for the color value for the new image at the location (u′,v′). In order to obtain a smooth result for color values, in particular an interpolation of color values of the surrounding pixels can be carried out, in particular a bilinear or bicubic interpolation. In the augmentation method, the new image can also be of the same size, or larger or smaller than the original image.

A simplified, reduced augmentation method consists of changing the size of the images, changing the resolution or cutting away parts of the image, as even these methods change intrinsic camera parameters to a certain extent.

By means of the augmentation method, new sequences with other intrinsics can be generated on the basis of each sequence in the training data set, so that the network can be trained to cover all of these camera models and/or intrinsics.

The system can also be trained with purely synthetic data in which ground-truth intrinsics, poses, and depths are known. By combining deep learning and classic optimization, the system generalizes well on real data.

By way of example, self-calibration was implemented as a proof of concept, wherein a SLAM system from publication [1] was used as a basis. This self-calibration system is referred to below as ‘DROID calib’. The calibration was tested on various sequences of the EuroC data set and compared with COLMAP, the best-known classic video-based method. It is important here that DROID calib was not trained on the EuroC data set but on the synthetic dataset TartanAir, i.e. the results show the performance with new, unknown data. The initial values of the intrinsic parameters were set to differ by 20% from the ground-truth values. The following table shows the calibration results as well as the required computing time of the two systems.

| | | | | | | ME | Time |
|---|---|---|---|---|---|---|---|
| Sequence | Method | fₓ | f_{y} | cₓ | c_{y} | (pixel) | (s) |
| | Ground-truth | 435.2 | 435.2 | 367.4 | 252.2 | — | — |
| | Initial | 522.2 | 522.2 | 440.9 | 302.6 | — | — |
| | values | | | | | | |
| MH01 | COLMAP | 431.7 | 434.9 | 367.8 | 253.6 | 0.67 | 1662 |
| | DROID | 432.3 | 433.9 | 368.7 | 252.9 | 0.52 | 367 |
| | calib | | | | | | |
| MH02 | COLMAP | 433.8 | 432.4 | 368.7 | 250.8 | 0.56 | 1217 |
| | DROID | 433.1 | 433.5 | 368.2 | 252.4 | 0.50 | 446 |
| | calib | | | | | | |
| MH03 | COLMAP | 459.8 | 436.6 | 376.7 | 250.2 | 5.0 | 1495 |
| | DROID | 431.2 | 432.6 | 368.4 | 253.7 | 1.0 | 240 |
| | calib | | | | | | |
| MH04 | COLMAP | 432.4 | 433.7 | 367.5 | 253.9 | 0.79 | 723 |
| | DROID | 431.7 | 431.9 | 368.3 | 252.9 | 1.0 | 139 |
| | calib | | | | | | |
| MH05 | COLMAP | 431.7 | 431.6 | 368.0 | 253.1 | 1.1 | 1264 |
| | DROID | 431.1 | 432.4 | 368.5 | 253.6 | 1.0 | 185 |
| | calib | | | | | | |

The results of DROID calib are close for all sequences in the ground-truth calibration. The imaging error is at most 1 pixel in the evaluated sequences. In particular, both calibration quality and computing time are comparable to, or better than, COLMAP. It should be noted here that the evaluated sequences contain various camera movements. It is to be expected that the calibration qualities of both methods will be lower with pure straight-ahead driving, since in this case geometric ambiguities basically occur with the camera movement.

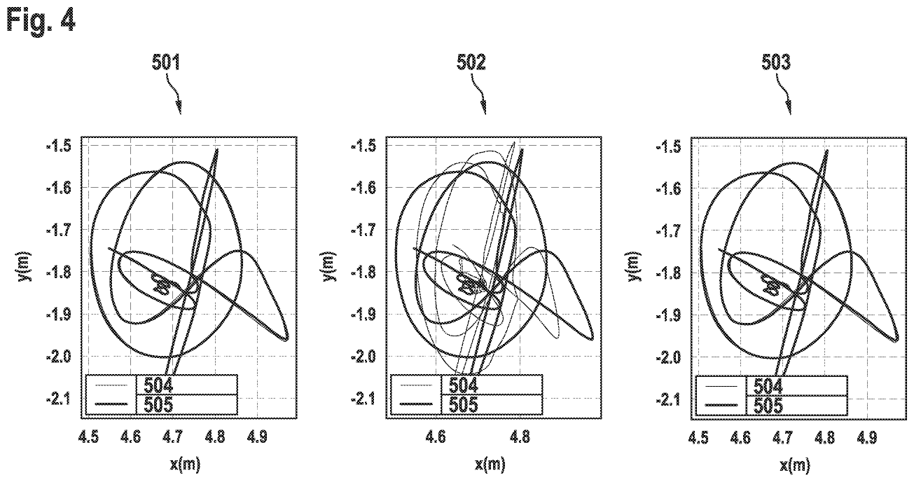

FIG. 4 shows by way of example that the self-calibration enables a significantly better estimation of trajectory should the calibration be unknown or encumbered with errors. Shown here by way of example are estimated trajectories of the method according to the present invention (DROID calib), wherein a SLAM system from publication [1] was used as the basis (DROID SLAM). Here illustration 501 shows the trajectory without calibration errors; illustration 502 shows 20% calibration errors when using the pure “DROID SLAM” from publication [1]; and illustration 503 shows 20% calibration errors when using “DROID calib”, i.e. the expansion of DROID SLAM according to the present invention. Here line 504 indicates the estimation and line 505 indicates the reference.

In summary, the advantages of the solution according to the present invention are better generalizability and explicability than pure deep learning systems. The advantage of optimization residuals and weights from deep neuronal networks, in contrast to classic keypoint-based methods, is to be found furthermore in the fact that deep neural networks are particularly performant in feature extraction from images, in the closeness of the correspondences (with classic keypoint-based methods, only a few keypoints and matches can be found, depending on the environment), and in the trained prediction of optimization weights (in the case of classic methods, correspondences are usually weighted equally).

In a further variant, it can also be possible for the intrinsics and thus the camera parameters to be known, wherein however the simultaneous prediction of the intrinsics is used for error detection in the network. In this case, the system for pose and depth estimation can be used, and the simultaneous intrinsics estimation is compared with the known intrinsics. If deviations exist, it can be concluded that the residuals predicted by the network are encumbered with errors and the depth and pose estimation could be correspondingly incorrect.

In addition, the uncertainty of the calibration can optionally be estimated, analogously to uncertainty estimation in the case of target-based calibration. By way of example, a correction of the intrinsics is carried out only when the uncertainty of the estimation is sufficiently low.

In a further variant, the number of correspondences can be reduced, since no close depth estimation is required for self-calibration. This can be achieved, for example, by including in the optimization only those correspondences with the highest weights. This reduces the computing time and memory required.

In a further variant, the intrinsics estimation cannot be activated unless the movement of the camera permits an intrinsics estimation—in other words, if the camera has moved and in particular if a rotation of the camera has taken place. In a further variant, the depths and/or the camera poses can be known (e.g., from another sensor). In the optimization, these parameters are then retained, which leads to a more robust calibration.

The above description of the embodiments describes the present invention exclusively in the context of examples. Of course, individual features of the embodiments, provided they make technical sense, can be freely combined with one another without departing from the scope of the present invention.

### REFERENCES

[1] Jiading Fang, Igor Vasiljevic, Vitor Guizilini, Rares Ambrus, Greg Shakhnarovich, Adrien Gaidon, and Matthew R Walter; “Self-supervised camera self-calibration from video;” arXiv preprint arXiv:2112.03325, 2021.
[2] Zachary Teed and Jia Deng; “Droid-slam: Deep visual slam for monocular, stereo, and rgbd cameras;” Advances in Neural Information Processing Systems, 34:16558-16569, 2021.

What is claimed is:

1. A computer-implemented method for self-calibration of at least one camera, comprising the following steps:
ascertaining at least two corresponding images from a sequence of recorded images, wherein the recorded images result from recordings of the camera, wherein the corresponding images have correspondences which are specific to at least one camera parameter, wherein the camera parameter is specific to a geometric imaging behavior of the camera;
ascertaining each respective correspondence of the correspondences by an application of an artificial neural network, wherein the application is carried out based on the corresponding images; and
determining at least the camera parameter based on the ascertained respective correspondences for the self-calibration of the camera.

2. The method according to claim 1, wherein the respective correspondences are specific to a relative camera pose, wherein the relative camera pose is specific to a relative movement of the camera and an environment of the camera between the recordings, wherein the application of the artificial neural network is carried out based on an initial estimation of a correspondence, wherein the initially estimated correspondence is determined by an initial estimation of the relative camera pose and/or a depth and/or the camera parameter.

3. The method according to claim 1, wherein the determination of at least the camera parameter includes an execution of an optimization method in which the camera parameter is estimated from the ascertained respective correspondences, wherein the respective correspondences are ascertained image-point-wise and the optimization method is carried out based on correspondences for several image points of the corresponding and/or further corresponding images in the sequence, wherein the optimization method carried out iteratively, wherein after a defined number of iterations, the step of ascertaining of the respective correspondences is repeated, wherein an initial estimation of the respective correspondence in each iteration corresponds to the result of the preceding iteration.

4. The method according to claim 1, further comprising:
before the ascertainment of the respective correspondence, performing an extraction of features of the corresponding images by a further neural network, wherein the ascertainment of the respective correspondence comprises the following steps, wherein the respective correspondence is ascertained as a correspondence between an image point of a first image of the corresponding images and an image point of a second image of the corresponding images, wherein the ascertainment of each respective correspondence is carried out as a prediction of the respective correspondence:
ascertaining a correlation based on the extracted features for the initially estimated correspondence, wherein the correlation is ascertained as a correlation between the extracted features in the environments of the image points, and
using the ascertained correlation and the initially estimated correspondence as an input for the neural network to use an output of the neural network as a correspondence that has been improved compared to the initial estimation.

5. The method according to claim 1, wherein the ascertainment of the respective correspondence includes the following steps:
initially ascertaining a geometric relationship between the corresponding images based on an initial estimation of a relative camera pose and the camera parameter,
determining an input of the neural network based on the ascertained geometric relationship, wherein an output of the neural network is used as the ascertained correspondence;
wherein in the step of determining the at least the camera parameter, using further processing of the ascertained correspondences, the camera parameters and the relative camera pose and/or a depth of the geometric relationship is determined.

6. The method according to claim 1, wherein the ascertainment of the respective correspondence includes a transformation based on a first image of the corresponding images, which is carried out based on an initial estimation of a relative camera pose and/or a depth and/or the camera parameter, wherein a result of the transformation is compared based on a second image of the corresponding images to evaluate the estimation.

7. The method according to claim 1, wherein the ascertained correspondences are each output as a residual and an assigned optimization weight output by the neural network, wherein the determination of at least the camera parameter for the self-calibration includes:
performing an optimization by weighting the residuals based on the optimization weights,
performing the self-calibration based on a result of the optimization;
wherein the optimization includes an iterative execution of Gauss-Newton steps, wherein after a defined number of iterations the step of ascertaining of the respective correspondence is repeated in order to ascertain the residuum and the assigned optimization weight again in each case.

8. The method according to claim 1, wherein the neural network is a deep neural network and/or a convolutional neural network and/or as a recurrent neural network.

9. The method according to claim 1, wherein the self-calibration includes a determination of a current intrinsic camera parameter of the camera during an ongoing operation of the camera, wherein the neural network has been trained for ascertaining the respective correspondence before the self-calibration.

10. A method for training an artificial neural network for ascertaining correspondences, comprising the following steps:
providing training data which are specific to images recorded by at least one camera, wherein the images contain corresponding images, wherein correspondences are specific to varying camera parameters, wherein the camera parameters are specific to a geometric imaging behavior of the camera; and
performing training based on the training data.

11. The method according to claim 10, wherein the training data are specific to varying camera parameters, and the training data are based on images of different camera lenses and/or of different focal length and/or of different lens distortions by use of fisheye lenses, and/or are characterized in that at least one of the following cost functions is provided during the training:
a cost function which is specific to a deviation of the camera parameter estimated in an optimization method from a camera parameter specified by ground truth,
a cost function which is specific to a deviation of a predicted correspondence from a correspondence specified by the ground truth,
a cost function which is specific to a deviation of camera poses estimated in an optimization method from camera poses specified by the ground truth,
a cost function quantifying a photometric error.

12. The method according to claim 10, wherein after performing the training, a method for self-calibration of at least one camera is performed, including the following steps:
ascertaining at least two corresponding images from a sequence of recorded images, wherein the recorded images result from recordings of the camera, wherein the corresponding images have correspondences which are specific to at least one camera parameter, wherein the camera parameter is specific to a geometric imaging behavior of the camera;
ascertaining each respective correspondence of the correspondences by an application of an artificial neural network, wherein the application is carried out based on the corresponding images; and
determining at least the camera parameter based on the ascertained respective correspondences for the self-calibration of the camera.

13. An augmentation method for generating training data, the method comprising the following steps:
transforming recorded and/or synthetic images which are specific to images recorded by at least one camera, wherein a camera parameter of the images is varied by the transformation; and
generating the training data from the transformed images.

14. A non-transitory computer-readable medium on which is stored a computer program including instructions for self-calibration of at least one camera, the instructions, when executed by a computer, causing the computer to perform the following steps:
ascertaining at least two corresponding images from a sequence of recorded images, wherein the recorded images result from recordings of the camera, wherein the corresponding images have correspondences which are specific to at least one camera parameter, wherein the camera parameter is specific to a geometric imaging behavior of the camera;
ascertaining each respective correspondence of the correspondences by an application of an artificial neural network, wherein the application is carried out based on the corresponding images; and
determining at least the camera parameter based on the ascertained respective correspondences for the self-calibration of the camera.

15. A device for data processing, the device configured for self-calibration of at least one camera, the device configured to:
ascertain at least two corresponding images from a sequence of recorded images, wherein the recorded images result from recordings of the camera, wherein the corresponding images have correspondences which are specific to at least one camera parameter, wherein the camera parameter is specific to a geometric imaging behavior of the camera;
ascertain each respective correspondence of the correspondences by an application of an artificial neural network, wherein the application is carried out based on the corresponding images; and
determine at least the camera parameter based on the ascertained respective correspondences for the self-calibration of the camera.
